(19) United States
(12) Patent Application Publication
(10) Pub. No.: US 2022/0237346 A1
(43) Pub. Date: Jul. 28, 2022

(54) SIMULATION METHOD, SIMULATION APPARATUS, AND NON-TRANSITORY COMPUTER READABLE MEDIUM STORING PROGRAM

(71) Applicant: SUMITOMO HEAVY INDUSTRIES, LTD., Tokyo (JP)

(72) Inventor: Ryunosuke Kitahara, Kanagawa (JP)

(21) Appl. No.: 17/581,551

(22) Filed: Jan. 21, 2022

(30) Foreign Application Priority Data
Jan. 22, 2021 (JP) 2021-008846

(51) Int. Cl. G06F 30/25

(52) U.S. Cl. CPC G06F 30/25; G06F 2119/06

(57) ABSTRACT

A simulation method includes coarse-graining a plurality of atoms that constitute a magnetic body to be simulated and generating a magnetic body model composed of a collection of particles, applying a magnetic moment to each of a plurality of the particles of the magnetic body model, obtaining a magnetic field due to an interparticle exchange interaction acting between the plurality of particles, based on an interatomic exchange interaction of the magnetic body, obtaining an oscillating magnetic field acting on each of the plurality of particles, based on an oscillating magnetic field originating from a thermal fluctuation acting on the atoms, obtaining a total magnetic field acting on each of the plurality of particles, based on the magnetic field and the oscillating magnetic field, and time-evolving the magnetic moment of each of the plurality of particles, based on the total magnetic field acting on each of the plurality of particles.

### RELATED APPLICATIONS

The content of Japanese Patent Application No. 2021-008846, on the basis of which priority benefits are claimed in an accompanying application data sheet, is in its entirety incorporated herein by reference.

### BACKGROUND

### Technical Field

A certain embodiment of the present invention relates to a simulation method, a simulation apparatus, and a non-transitory computer readable medium storing a program.

### Description of Related Art

As a method for simulating magnetization in a magnetic body, a micromagnetic method and anatomic spin method are known in the related art. In the micromagnetic method, a magnetic body is divided into meshes of several tens of nanometers and analyzed by the finite element method. In the atomic spin method, first-principle calculation is performed in consideration of the atomic arrangement at nanometer intervals and the atomic spin.

### SUMMARY

According to an embodiment of the present invention, there is provided a simulation method including:

coarse-graining a plurality of atoms that constitute a magnetic body to be simulated and generating a magnetic body model composed of a collection of a smaller number of particles than an original number of the atoms;

applying a magnetic moment to each of a plurality of the particles of the magnetic body model;

obtaining a magnetic field due to an interparticle exchange interaction acting between the plurality of particles of the magnetic body model, based on an interatomic exchange interaction of the magnetic body;

obtaining an oscillating magnetic field acting on each of the plurality of particles of the magnetic body model, based on an oscillating magnetic field originating from a thermal fluctuation acting on the atoms of the magnetic body;

obtaining a total magnetic field acting on each of the plurality of particles of the magnetic body model, based on the magnetic field due to the interparticle exchange interaction and the oscillating magnetic field acting on the particles of the magnetic body model; and

time-evolving the magnetic moment of each of the plurality of particles, based on the total magnetic field acting on each of the plurality of particles of the magnetic body model.

According to another embodiment of the present invention, there is provided a simulation apparatus including:

an input device to which simulation conditions including coarse-grained conditions are input; and

a processing device that obtains a distribution of a magnetic moment of a magnetic body to be simulated, based on the simulation conditions input to the input device.

The processing device
coarse-grains a plurality of atoms that constitute the magnetic body, based on the input coarse-grained conditions, and generates a magnetic body model composed of a collection of a smaller number of particles than an original number of the atoms,
applies the magnetic moment to each of a plurality of the particles of the magnetic body model,
obtains a magnetic field due to an interparticle exchange interaction acting between the plurality of particles of the magnetic body model, based on an interatomic exchange interaction of the magnetic body,
obtains an oscillating magnetic field acting on each of the plurality of particles of the magnetic body model, based on an oscillating magnetic field originating from a thermal fluctuation acting on the atoms of the magnetic body,
obtains a total magnetic field acting on each of the plurality of particles of the magnetic body model, based on the magnetic field due to the interparticle exchange interaction and the oscillating magnetic field acting on the particles of the magnetic body model, and

time-evolves the magnetic moment of each of the plurality of particles of the magnetic body model, based on the total magnetic field.

According to still embodiment of the present invention, there is provided a non-transitory computer readable medium storing a program that causes a computer to execute a process including:

coarse-graining a plurality of atoms that constitute a magnetic body to be simulated and generating a magnetic body model composed of a collection of a smaller number of particles than an original number of the atoms;

applying a magnetic moment to each of a plurality of the particles of the magnetic body model;

obtaining a magnetic field due to an interparticle exchange interaction acting between the plurality of particles of the magnetic body model, based on an interatomic exchange interaction of the magnetic body;

obtaining an oscillating magnetic field acting on each of the plurality of particles of the magnetic body model, based on an oscillating magnetic field originating from a thermal fluctuation acting on the atoms of the magnetic body;

obtaining a total magnetic field acting on each of the plurality of particles of the magnetic body model, based on the magnetic field due to the interparticle exchange interaction and the oscillating magnetic field acting on the particles of the magnetic body model; and

time-evolving the magnetic moment of each of the plurality of particles of the magnetic body model, based on the total magnetic field.

### BRIEF DESCRIPTION OF THE DRAWINGS

FIG. 1A is a diagram schematically illustrating a plurality of atoms constituting a magnetic body to be simulated, and FIG. 1B is a diagram schematically illustrating a magnetic body model generated by coarse-graining a plurality of atoms constituting the magnetic body illustrated in FIG. 1A.

FIG. 2 is a schematic diagram of two particles for explaining parameters V, W, and S.

FIG. 3 is a block diagram of a simulation apparatus according to an embodiment.

FIG. 4 is a flowchart of a simulation method according to the embodiment.

FIGS. 5A to 5D, 5F, and 5G are diagrams illustrating the distribution of directions of magnetic moments obtained by simulation in shades, and FIG. 5E is a diagram schematically illustrating the directions of the magnetic moments illustrated in FIGS. 5A to 5D.

FIGS. 6A and 6B are diagrams illustrating the results of simulation with the radii r of the particles being 1 nm and 100 nm, respectively.

FIG. 7 is a graph showing a relationship between the normalized magnetization calculated from the simulation results and the temperature.

### DETAILED DESCRIPTION

In the micromagnetic method, it is difficult to perform an analysis in consideration of the interaction occurring in the microscopic region at the atomic level. The atomic spin method can reproduce microscopic physical phenomena, but the size of the calculation area that can be analyzed is small, and it is more difficult to analyze the magnetization of magnetic bodies such as magnetic heads and motor parts, due to limitation such as calculation time and memory capacity. In the atomic spin method described in the related art, a plurality of atoms are coarse-grained to reduce the number of particles to be calculated, thereby relaxing the limitation of the calculation area due to the calculation time, memory capacity, and the like. However, coarse-graining makes it impossible to reproduce the exchange interaction between atoms and the oscillating magnetic field originating from thermal fluctuation.

It is desirable to provide a simulation method, a simulation apparatus, and a non-transitory computer readable medium storing a program, capable of reducing the amount of calculation by coarse-graining a plurality of atoms constituting a magnetic body and reproducing the exchange interaction and the oscillating magnetic field to analyze the distribution of magnetization.

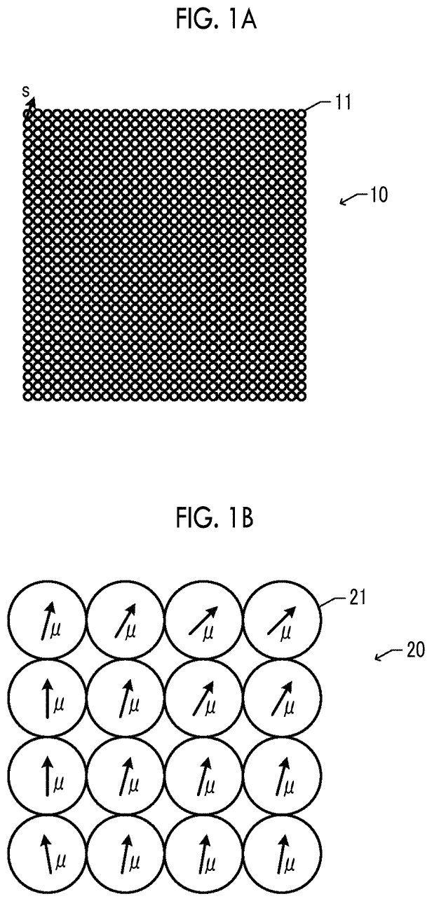

A simulation method and a simulation apparatus according to an embodiment will be described with reference to FIGS. 1A to 7.

FIG. 1A is a diagram schematically illustrating a plurality of atoms 11 constituting a magnetic body 10 to be simulated. Actually, the plurality of atoms 11 are three-dimensionally distributed in the magnetic body 10, but FIG. 1A illustrates an example in which the plurality of atoms 11 are two-dimensionally distributed. In FIG. 1A, a plurality of atoms 11 located on one virtual plane in the magnetic body 10 are considered.

Each of the plurality of atoms 11 has an atomic spin s. The Hamiltonian H₁^{exch} of the interatomic exchange interaction acting on the i-th atom 11 is defined by the following expression.

$${ℋ}_{i}^{exch} = - J {\sum }_{j = 1}^{z} {s}_{i} \cdot {s}_{j} \qquad ( 1 )$$

Here, J is an exchange interaction intensity coefficient representing the intensity of the exchange interaction between atoms, sᵢ and sⱼ are atomic spins of the i-th and j-th atoms, respectively, and sigma means the sum of all the atoms 11 adjacent to the i-th atom 11. z is the number of atoms 11 adjacent to the i-th atom 11. Vectors are illustrated in bold in the drawings and in expressions herein.

The magnetic field hᵢ^{exch} due to the interatomic exchange interaction acting on the i-th atom 11 is expressed by the following expression.

$${h}_{i}^{exch} = - \frac{\partial {ℋ}_{i}^{exch}}{\partial {μ}_{i}} \qquad ( 2 )$$

Here, sᵢ in Expression (1) and μᵢ in Expression (2) have the following relationship.

μᵢ=−gμ_{B}sᵢ (3)

Here, g is a g-factor, and usually the g-factor is about 2. μ_{B} is a Bohr magneton. μᵢ represents the magnetic moment of one atom.

The magnetic field hᵢ^{exch} due to the interatomic exchange interaction acting on the i-th atom 11 is described by the following expression, by using atomic spin.

$${h}_{i}^{exch} = - \frac{J}{g {μ}_{B}} {\sum }_{j = 1}^{z} {s}_{j} \qquad ( 4 )$$

The temporal change of the magnetic moments μ of the plurality of atoms 11 can be expressed by the following Landau-Lifshits-Gilbert equation (LLG equation).

$$\frac{d μ}{dt} = - \frac{γ}{1 + {α}^{2}} μ \times h - \frac{α γ}{( 1 + {α}^{2} ) \vert μ \vert} μ \times ( μ \times h ) \qquad ( 5 )$$

Here, h is a magnetic field acting on the atoms 11, α is an attenuation constant, and γ is a magnetic rotation ratio.

The magnetic moment μ(t+Δt) at time t+Δt is expressed by the following expression using the magnetic moment μ(t) at time t.

$$μ ( t + Δ t ) = μ ( t ) + \frac{d μ}{dt} \cdot Δ t \qquad ( 6 )$$

The oscillating magnetic field hᵢ^{th} originating from the thermal fluctuation acting on the i-th atom 11 is expressed by the following expression.

$${h}_{i}^{th} = \sqrt{\frac{2 kT α}{γ {μ}_{B} {M}_{s} Δ t}} {Γ}_{i} ( t ) \qquad ( 7 )$$

Here, k is the Boltzmann constant, T is the set temperature, Mₛ is the saturation magnetization constant, Δt is the time step width, and Γᵢ (t) is a three-dimensional direction unit vector changing randomly in time.

### Atom Coarse-Graining

FIG. 1B is a diagram schematically illustrating a magnetic body model 20 generated by coarse-graining a plurality of atoms 11 constituting the magnetic body 10 illustrated in FIG. 1A. The magnetic body model 20 is composed of a collection of coarse-grained particles 21 with a smaller number than the original number of the atoms in the magnetic body 10. A magnetic moment p is applied to each of the plurality of particles 21, based on the atomic spins s of the atoms 11 in the magnetic body 10. In the calculation, the magnetic moment p of the particle 21 is, for example, a unit vector having a length of 1.

The magnetic field h′ᵢ acting on the i-th particle 21 can be obtained by the following expression.

h′ᵢ=h′ᵢ^{ext}+h′ᵢ^{dipole}+h′ᵢ^{anis}+h′ᵢ^{exch}+h′ᵢ^{th} (8)

Here, h′ᵢ^{ext} is an external magnetic field, h′ᵢ^{dipole} is a magnetic field due to uniaxial crystal anisotropic interaction, and h′ᵢ^{anis} is the magnetic field due to dipole interaction, h′ᵢ^{exch} is the magnetic field due to interparticle exchange interaction, and h′ᵢ^{th} is the oscillating magnetic field.

The external magnetic field h′ᵢ^{ext} is generated in the entire region to be calculated and is given as a simulation condition. The magnetic field h′ᵢ^{dipole} due to uniaxial crystal anisotropic interaction, and the magnetic field h′ᵢ^{anis} due to dipole interaction can be expressed by the following expression.

$${h}_{i}^{′ dipole} = \frac{1}{4 π} {\sum }_{j} ( \frac{3 ( {μ}_{j} \cdot {\hat{r}}_{ij} ) {\hat{r}}_{ij} - {μ}_{j}}{{r}_{ij}^{3}} ) \\ {h}_{i}^{′ anis} = 2 K ( {μ}_{i} \cdot e ) e \qquad ( 9 )$$

Here, the rᵢⱼ hat is a unit vector parallel to the vector whose starting point is the position of the j-th particle 21 and the ending point is the position of the i-th particle 21. rᵢⱼ is the distance from the j-th particle 21 to the i-th particle 21. μⱼ is the magnetic moment of the j-th particle 21. e is a magnetization-friendly axis vector, and K is a magnetic anisotropy constant.

### Interparticle Exchange Interaction

In the present embodiment, it is assumed that interparticle exchange interaction equivalent to an interatomic exchange interaction acts between two adjacent particles 21.

The Hamiltonian of the interparticle exchange interaction between particles 21 of the magnetic body model 20 (FIG. 1B) is defined as follows.

$${ℋ}_{i}^{′ exch} = - {J ( \frac{W \cdot S}{V} )}^{2} {{\sum }_{i}}^{z} {μ}_{i} \cdot {μ}_{j} \qquad ( 10 )$$

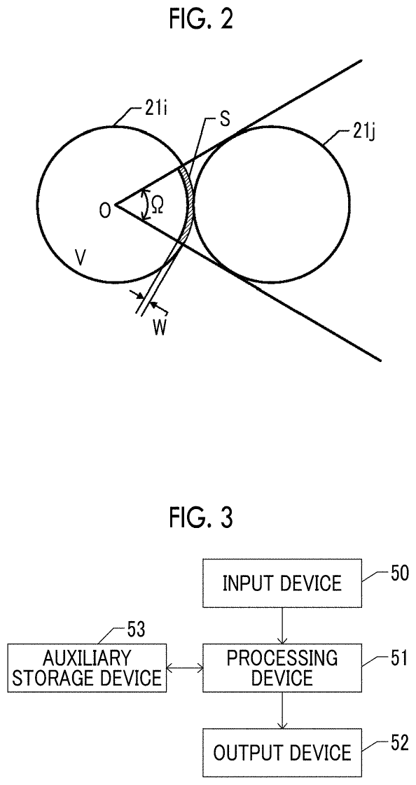

J is the same as the exchange interaction intensity coefficient J in Expression (1). The parameters V, W, and S will be described with reference to FIG. 2. μᵢ and μⱼ are magnetic moments of the i-th and j-th particles 21, respectively.

FIG. 2 is a schematic diagram of two particles 21 for explaining parameters V, W, and S. The i-th particle 21i and the j-th particle 21j are adjacent to each other. The V on the right side of Expression (10) represents the volume of the particle 21. S represents the surface area of the i-th particle 21i in the range of the solid angle Ω that allows the j-th particle 21j to be seen from the center O of the i-th particle 21i. W is a parameter having a dimension of length. For example, as the value of W, the thickness of a single atomic layer located on the surface of the i-th particles 21i can be adopted. In this case, the value of W is equal to the diameter of the atom 11 of the magnetic body 10 (FIG. 1A). In FIG. 2, hatching is attached to a portion corresponding to the volume of W·S.

Next, the physical meaning of Expression (10) will be described.

In the magnetic body 10 (FIG. 1A), an interatomic exchange interaction acts between the atoms 11 adjacent to each other. The particles 21 of the magnetic body model 20 (FIG. 1B) are considered to represent a plurality of atoms 11. When the interparticle interaction acting between two particles 21 is defined by using Expression (1), the state in which the interatomic exchange action is acting between two atoms 11 which are not adjacent to each other in the magnetic body 10 is reproduced. Therefore, it is considered that the interparticle exchange interaction acts only between portions facing each other at a short distance, among the surfaces of the particles 21 adjacent to each other. In the present embodiment, a surface within a range of a solid angle Ω that allows the j-th particle 21j to be seen from the center O of the i-th particle 21i is adopted as the “portions facing each other at a short distance”.

Further, considering that only the atoms of one atomic layer located on the surface contribute to the interparticle exchange interaction, the volume of the portion contributing to the interparticle exchange interaction is represented by W·S. The term (W·S/V) on the right side of Expression (10) corresponds to the ratio of the volume of the portion contributing to the interparticle exchange interaction to the volume of the particles 21 (hereinafter referred to as an effective volume ratio). In the calculation of the Hamiltonian H′ᵢ^{exch} of the interparticle exchange interaction, the magnetic moments μᵢ and μⱼ of the i-th particle 21i and the j-th particle 21j that exert the interparticle exchange interaction are multiplied by the effective volume ratio, and weakened magnetic moment is used. That is, in the simulation of the magnetic body model 20 (FIGS. 1A and 1B), the entire magnetic moments μ of the particles 21 do not contribute to the interparticle exchange interaction, but weakened magnetic moments (W·S/V) μ according to the effective volume ratio are considered to contribute to the interparticle exchange interaction.

The magnetic field h′ᵢ^{exch} due to the interparticle exchange interaction can be expressed by the following expression, by using the Hamiltonian of the interparticle exchange interaction defined by Expression (10).

$${h}_{i}^{′ exch} = - \frac{\partial {ℋ}_{i}^{′ exch}}{\partial {μ}_{i}} \qquad ( 11 )$$

### Oscillating Magnetic Field

Next, the oscillating magnetic field originating from thermal fluctuation will be described.

When the radius of the particle 21 that is coarse-grained atoms is λ times the atomic radius, the magnetic field h′ᵢ^{exch} due to the exchange interaction acting on the particle 21 can be expressed as follows by using the function f(λ) of λ. In the present specification, λ is referred to as a particle enlargement ratio.

$${h}_{i}^{′ exch} = f ( λ ) {h}_{i}^{exch} = - Jf ( λ ) {{\sum }_{j}}^{z} {μ}_{j} \\ f ( λ ) = \{ \begin{matrix}1 & ( λ = 1 ) \\ {( \frac{3}{λ \cdot z} )}^{2} & ( λ > 1 )\end{matrix} \qquad ( 12 )$$

Here, z is the number of particles located in the vicinity.

By formulating the oscillating magnetic field h′ᵢ^{th} acting on the particles 21 in response to the magnetic field due to the exchange interaction shown in Expression (12) as follows, the temperature dependence of the magnetization can be reproduced.

$${h}_{i}^{′ th} = \sqrt{f ( λ )} {h}_{i}^{th} = \sqrt{\frac{2 f ( λ ) kT α}{γ {μ}_{B} {M}_{s} Δ t}} {Γ}_{i} ( t ) \qquad ( 13 )$$

Expression (7) is used in the modification of Expression (13).

f(λ) in Expression (12) is a coefficient for converting the magnetic field due to the interatomic exchange interaction in the magnetic body 10 (FIG. 1A) into the interparticle exchange interaction in the magnetic body model 20 (FIG. 1B). In Expression (13), the square root of f(λ) is used as a coefficient for converting the oscillating magnetic field acting on the atoms of the magnetic body 10 into the oscillating magnetic field acting on the particles of the magnetic body model 20.

Next, the physical meaning of Expression (13) will be described. Since the exchange interaction intensity coefficient J, which is the origin of spontaneous magnetization, changes due to coarse-graining, the amount of energy (Hamiltonian value) in the calculation system also changes. By changing the amount of energy dissipation in the system in response to the change in the amount of energy in the system due to coarse-graining, the temperature dependence in the system before coarse-graining can be maintained in the system after coarse-graining.

Since the amount of energy dissipation is the variance of the random field, that is, the square mean of Expression (7), the ratio of the amount of energy (Hamiltonian value) to the magnitude of the energy dissipation amount remains unchanged before and after coarse-graining, by multiplying the root on the right side of Expression (7) by the function f(λ) of Expression (12). That is, in Expression (13), the term of temperature fluctuation is converted such that the ratio of the Hamiltonian value to the magnitude of the energy dissipation amount does not change before and after coarse-graining.

### Simulation Apparatus

FIG. 3 is a block diagram of a simulation apparatus according to an embodiment. The simulation apparatus according to the embodiment includes an input device 50, a processing device 51, an output device 52, and an external storage device 53. Simulation conditions or the like are input from the input device 50 to the processing device 51. Further, various commands or the like are input from the operator to the input device 50. The input device 50 includes, for example, a communication device, a removable media reading device, a keyboard, or the like.

The processing device 51 performs simulation calculation based on the input simulation conditions and commands. The processing device 51 is a computer including a central processing unit (CPU), a main storage device (main memory), and the like. The simulation program executed by the computer is stored in the external storage device 53. For the external storage device 53, for example, a hard disk drive (HDD), a solid state drive (SSD), or the like is used. The processing device 51 reads the program stored in the external storage device 53 into the main storage device and executes the program.

The processing device 51 outputs the simulation result to the output device 52. The simulation result includes information indicating the magnetic moment applied to each of a plurality of particles representing the member to be analyzed, the temporal change of the physical quantity of the particle system composed of the plurality of particles, or the like. The output device 52 includes, for example, a communication device, a removable media writing device, a display, a printer, and the like.

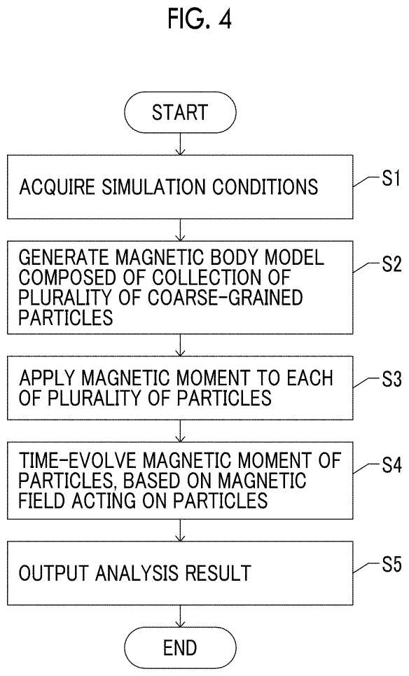

FIG. 4 is a flowchart of a simulation method according to the embodiment.

First, the processing device 51 acquires the simulation conditions input to the input device 50 (step S1). The simulation conditions include the physical property values of the magnetic body 10 (FIG. 1A) to be simulated, the shape of the magnetic body 10, the external magnetic field, the coarse-grained conditions, the initial conditions, the time step width in the simulation calculation, and the like.

When acquiring the simulation conditions, the processing device 51 generates the magnetic body model 20 (FIG. 1B), based on the acquired simulation conditions (step S2). Thus, the magnitude and position of the plurality of coarse-grained particles 21 (FIG. 1B) are determined. Further, a magnetic moment μ is applied to each of the plurality of particles 21 (step S3). The direction of the magnetic moment p is set at random, for example.

After applying the magnetic moment p to each of the particles 21, the magnetic moment of the particles 21 is time-evolved by using the magnetic field h′ᵢ acting on each particle 21 (step S4). The magnetic field h′ᵢ acting on each particle is given by Expression (8). Each magnetic field on the right side of Expression (8) is given by Expressions (9), (10), (11), and (13). Expressions (5) and (6) are used for the time evolution of the magnetic moment of the particle 21. Expressions (5) and (6) show the magnetic moment of the atom 11 that has not been coarse-grained, but the change in the magnetic moment of the particle 21 after coarse-graining can be also calculated using the same expression as Expressions (5) and (6).

The calculation in step S4 is repeated until the end condition is satisfied. For example, when the magnetization state of the magnetic body model 20 becomes a steady state, the iterative process of step S4 is completed. When the end condition is satisfied, the processing device 51 outputs the analysis result to the output device 52 (step S5). As the analysis result, for example, the distribution of the directions of the magnetic moments μ may be displayed by a plurality of arrows, or the distribution of the directions of the magnetic moments μ may be displayed in shades of color or the like.

Next, the excellent effects of the above embodiment will be described.

In the above embodiment, the calculation time can be shortened by coarse-graining the plurality of atoms 11 (FIG. 1A) of the magnetic body 10. By defining interparticle exchange interaction corresponding to an exchange interaction acting between atoms by Expressions (10) and (11), between a plurality of coarse-grained particles 21 (FIG. 1B), the interatomic exchange interaction can be reflected in the simulation result. Further, by defining the oscillating magnetic field acting on the particles 21 by Expression (13), the influence of the oscillating magnetic field originating from the thermal fluctuation can be reflected in the simulation result. For example, it becomes possible to reproduce, by simulation, the phase transition phenomenon when the temperature changes over the Curie temperature at which the phase transition occurs.

Simulation without Considering Oscillating Magnetic Field

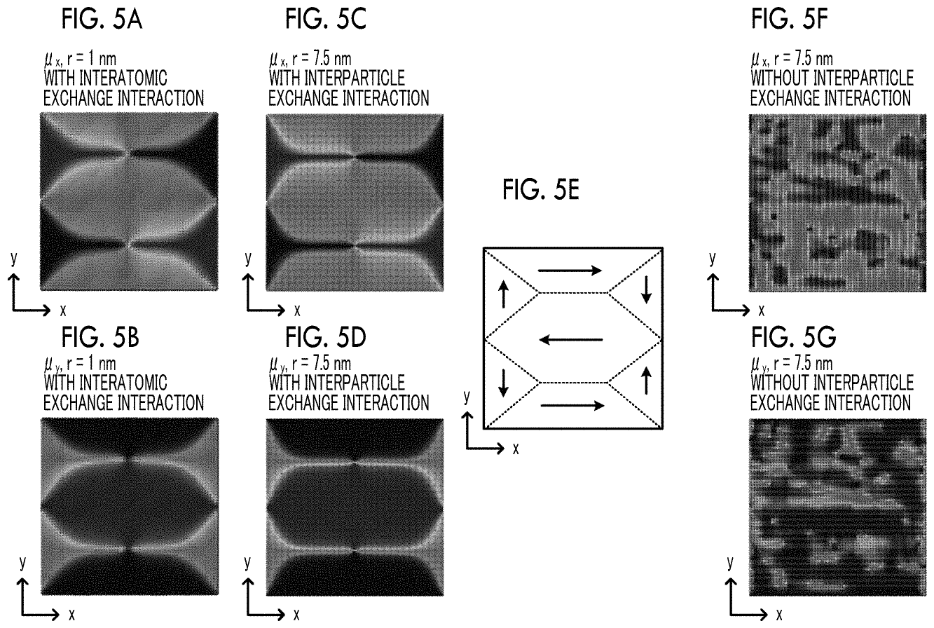

Next, with reference to FIGS. 5A to 5G, results of an actual simulation performed to check the excellent effect of the above embodiment will be described. The following simulation does not consider the oscillating magnetic field.

FIGS. 5A to 5D, 5F, and 5G are diagrams illustrating the distribution of the directions of magnetic moments obtained by simulation in shades. FIG. 5E is a diagram schematically illustrating the directions of the magnetic moments illustrated in FIGS. 5A to 5D. The calculation area in the simulation is a two-dimensional square with a side length of 50 nm. An xy Cartesian coordinate system is defined in the calculation area. When the radii of the coarse-grained particles 21 is 1 nm and 7.5 nm, respectively, the magnetic moments are time-evolved until the magnetic moment distribution of the particles 21 reaches a steady state. The particles 21 are arranged at the positions of the lattice points of the square lattice, and as initial conditions, the distribution of the directions of the magnetic moments are the same in all of FIGS. 5A to 5D, 5F, and 5G.

FIGS. 5A and 5B illustrate the simulation results of the magnetic moments when the radius r of the coarse-grained particle 21 is 1 nm. FIGS. 5C, 5D, 5F, and 5G illustrate the simulation results of the magnetic moments when the radius r of the coarse-grained particle 21 is 7.5 nm. Note that FIGS. 5F and 5G illustrate the results of simulations performed under the condition that the interparticle exchange interaction does not act between the coarse-grained particles 21.

FIGS. 5A, 5C, and 5F illustrate the magnitudes of the y components of the magnetic moments, and FIGS. 5B, 5D, and 5G illustrate the magnitudes of the x components of the magnetic moments. The region where the absolute values of the x and y components of the magnetic moments are large is illustrated relatively dark. The outline of the direction of the magnetic moment of each region divided by shades in FIGS. 5A to 5D is illustrated by an arrow in FIG. 5E.

In the simulations in which the interparticle exchange interaction is considered, the results of simulation (FIGS. 5A and 5B) with the particle radius r set to 1 nm and the results of simulation (FIGS. 5C and 5D) with the particle radius r set to 7.5 nm, a clear magnetic domain structure with aligned magnetic moment direction is checked. On the other hand, the magnetic domain structure does not appear in the results of the simulation (FIGS. 5F and 5G) in which the interparticle exchange interaction is not considered. From this simulation results, it can be seen that the interatomic exchange interaction of the magnetic body 10 to be simulated is appropriately reproduced in the coarse-grained magnetic body model 20.

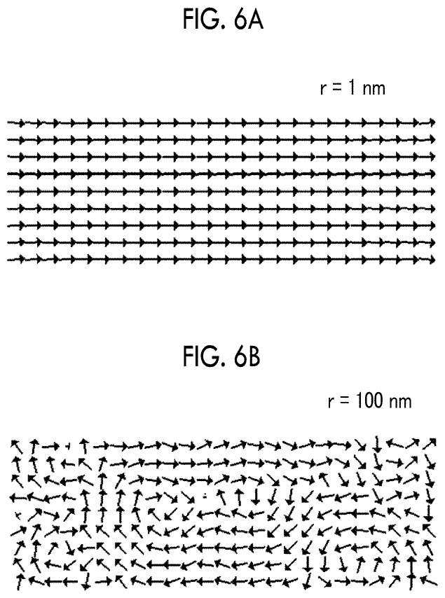

Next, the results of the simulation performed to check the degree of influence of the exchange interaction will be described with reference to FIGS. 6A and 6B.

FIGS. 6A and 6B are diagrams illustrating the results of simulation with the radii r of the particles 21 being 1 nm and 100 nm, respectively. In FIGS. 6A and 6B, the directions of the magnetic moments when the distribution of the magnetic moment reaches a steady state are indicated by arrows. The simulation area is a two-dimensional rectangle, and 24 and 9 particles 21 are arranged in the length direction and the width direction, respectively.

In the simulation results illustrated in FIG. 6A, the magnetic moments of all the particles 21 are oriented in substantially the same direction. This is because the interparticle exchange interaction acts stronger than the uniaxial crystal anisotropic interaction and the dipole interaction. On the other hand, in the simulation result illustrated in FIG. 6B, the annular magnetic domain structure is checked. This is because the interparticle exchange interaction is relatively weakened, and the uniaxial crystal anisotropic interaction and the dipole interaction become apparent.

In both the simulations of FIGS. 6A and 6B, the number of target particles 21 is the same. Therefore, the calculation times for both are almost equal. Further, in the simulation of FIG. 6A, the rectangular region of 48 nm in width and 18 nm in length is the calculation target, whereas in the simulation of FIG. 6B, the rectangular region of 4800 nm in width and 1800 nm in length is the calculation target. In this way, by adopting the method according to the above embodiment, it is possible to expand the calculation area while suppressing the lengthening of the calculation time. Thus, it is possible to suppress an increase in calculation cost when simulating the magnetic moments of a large magnetic body.

### Simulation Considering Oscillating Magnetic Field

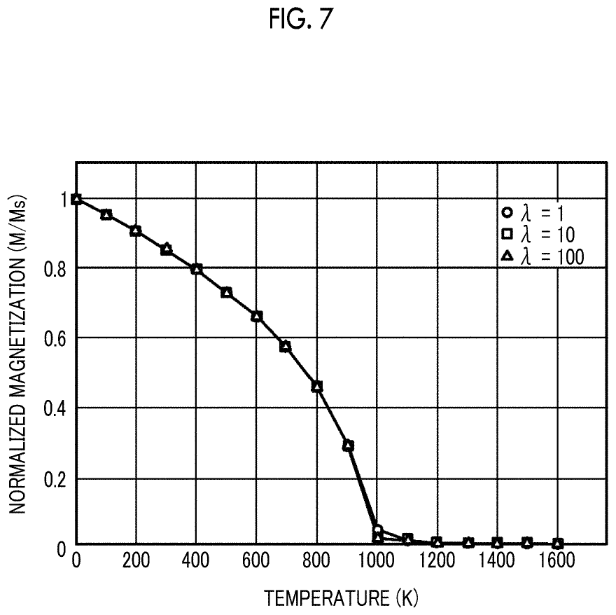

Next, with reference to FIG. 7, results of another actual simulation performed to check the excellent effect of the above embodiment will be described. In the following simulation, the magnetic field and the oscillating magnetic field due to the interparticle exchange interaction are considered.

The particle enlargement ratios λ are set to 1, 10, or 100, and the magnetization temperature characteristics are obtained by simulation. The crystal structure is a body-centered cubic lattice (BCC), and the number of crystal lattices is 22×22×22. The value of iron is used as the physical property value of the object to be analyzed. Calculations are performed until steady state is reached at each of the plurality of temperatures. The magnitude M of the average vector of the magnetic moments of all the particles to be analyzed in the steady state is obtained.

FIG. 7 is a graph showing the relationship between the normalized magnetization calculated from the simulation results and the temperature. The horizontal axis represents the temperature in the unit “K”, and represents the normalized magnetization in which the magnitude of the average vector of the magnetic moments of all the particles is normalized by the saturation magnetization Mₛ. The circle symbol, square symbol, and triangle symbol in the graph indicate the simulation results when the particle enlargement ratios λ are 1, 10, and 100, respectively.

When the particle enlargement ratio λ is 1, 10, or 100, the magnetization decreases as the temperature rises, and when the temperature slightly exceeds 1000 K, the magnetization becomes almost zero. The temperature at which the magnetization becomes almost zero is almost equal to the Curie temperature of iron 1043K.

From the simulation shown in FIG. 7, it is confirmed that it is possible to apply the method according to the present embodiment to perform a simulation reflecting the interatomic exchange interaction and the oscillating magnetic field.

Next, a modified example of the above embodiment will be described.

In the above embodiment, as illustrated in Expression (10), when determining the Hamiltonian of the interparticle exchange interaction, a value obtained by weakening the magnetic moment applied to the particles 21 according to the value of (W·S/V) is used. That is, the magnetic field due to the interparticle exchange interaction is calculated by weakening the interparticle exchange interaction. The coefficient for weakening the magnetic moment applied to the particle 21 is not limited to (W·S/V), and other coefficients less than 1 may be used. By weakening the interparticle exchange interaction, it is possible to make the uniaxial crystal anisotropic interaction and the dipole interaction apparent, while considering the interparticle exchange interaction. The coefficient for weakening the magnetic moment may be set to a value larger than 0 and smaller than 1, based on the magnitude and shape of the magnetic body 10 (FIG. 1A) to be simulated, the physical property value of the magnetic body, and the like.

It should be understood that the invention is not limited to the above-described embodiment, but may be modified into various forms on the basis of the spirit of the invention. Additionally, the modifications are included in the scope of the invention.

What is claimed is:

1. A simulation method comprising:
coarse-graining a plurality of atoms that constitute a magnetic body to be simulated and generating a magnetic body model composed of a collection of a smaller number of particles than an original number of the atoms;
applying a magnetic moment to each of a plurality of the particles of the magnetic body model;
obtaining a magnetic field due to an interparticle exchange interaction acting between the plurality of particles of the magnetic body model, based on an interatomic exchange interaction of the magnetic body;
obtaining an oscillating magnetic field acting on each of the plurality of particles of the magnetic body model, based on an oscillating magnetic field originating from a thermal fluctuation acting on the atoms of the magnetic body;
obtaining a total magnetic field acting on each of the plurality of particles of the magnetic body model, based on the magnetic field due to the interparticle exchange interaction and the oscillating magnetic field acting on the particles of the magnetic body model; and
time-evolving the magnetic moment of each of the plurality of particles, based on the total magnetic field acting on each of the plurality of particles of the magnetic body model.

2. The simulation method according to claim 1, wherein
as a coefficient for converting an oscillating magnetic field acting on the atoms of the magnetic body into the oscillating magnetic field acting on the particles of the magnetic body model, a square root of a coefficient for converting a magnetic field due to the interatomic exchange interaction of the magnetic body into the magnetic field due to the interparticle exchange interaction of the magnetic body model is used.

3. A simulation apparatus comprising:
an input device to which simulation conditions including coarse-grained conditions are input; and
a processing device that obtains a distribution of a magnetic moment of a magnetic body to be simulated, based on the simulation conditions input to the input device, wherein
the processing device
coarse-grains a plurality of atoms that constitute the magnetic body, based on the input coarse-grained conditions, and generates a magnetic body model composed of a collection of a smaller number of particles than an original number of the atoms,
applies the magnetic moment to each of a plurality of the particles of the magnetic body model,
obtains a magnetic field due to an interparticle exchange interaction acting between the plurality of particles of the magnetic body model, based on an interatomic exchange interaction of the magnetic body,
obtains an oscillating magnetic field acting on each of the plurality of particles of the magnetic body model, based on an oscillating magnetic field originating from a thermal fluctuation acting on the atoms of the magnetic body,
obtains a total magnetic field acting on each of the plurality of particles of the magnetic body model, based on the magnetic field due to the interparticle exchange interaction and the oscillating magnetic field acting on the particles of the magnetic body model, and
time-evolves the magnetic moment of each of the plurality of particles of the magnetic body model, based on the total magnetic field.

4. A non-transitory computer readable medium storing a program that causes a computer to execute a process comprising:
coarse-graining a plurality of atoms that constitute a magnetic body to be simulated and generating a magnetic body model composed of a collection of a smaller number of particles than an original number of the atoms;
applying a magnetic moment to each of a plurality of the particles of the magnetic body model;
obtaining a magnetic field due to an interparticle exchange interaction acting between the plurality of particles of the magnetic body model, based on an interatomic exchange interaction of the magnetic body;
obtaining an oscillating magnetic field acting on each of the plurality of particles of the magnetic body model, based on an oscillating magnetic field originating from a thermal fluctuation acting on the atoms of the magnetic body;
obtaining a total magnetic field acting on each of the plurality of particles of the magnetic body model, based on the magnetic field due to the interparticle exchange interaction and the oscillating magnetic field acting on the particles of the magnetic body model; and
time-evolving the magnetic moment of each of the plurality of particles of the magnetic body model, based on the total magnetic field.
